(19) United States
(12) Patent Application Publication
(10) Pub. No.: US 2008/0221996 A1
(43) Pub. Date: Sep. 11, 2008

(54) Non-intrusive advertising using a mobile terminal

(76) Inventors: Mark S. Lucas, Roanoke, VA (US); Ryan J. Eller, Dallas, TX (US); Scott Hudson, Roanoke, VA (US); Lewis Thomas, Roanoke, VA (US)

Correspondence Address: MCKENNA LONG & ALDRIDGE LLP, 1900 K STREET, NW, WASHINGTON, DC, 20006, US

(21) Appl. No.: 12/071,803

(22) Filed: Feb. 26, 2008

Related U.S. Application Data
(60) Provisional application No. 60/903,345, filed on Feb. 26, 2007.

(51) Int. Cl. G06Q 30/00

(52) U.S. Cl. 705/14

(57) ABSTRACT

Methods and apparatus useful for non-intrusive advertising on a mobile wireless communications terminal are disclosed. A method may include storing, according to a timed schedule, a plurality of files containing data representative of a plurality of advertising images in a memory of the mobile wireless communications terminal; and selecting, upon occurrence of a predefined event, one of the plurality of files for display as wallpaper on a display screen of the mobile wireless communications terminal. A method may include waiting for an occurrence of a event; determining, upon the occurrence of the event, if a contraindicated condition is present in the mobile wireless communications terminal, and if the contraindicated condition is not present: performing a first set of actions, but if the contraindicated condition is present: waiting for another occurrence of the predefined event.

This application claims priority to U.S. Provisional Application Ser. No. 60/903,345, filed Feb. 26, 2007 the contents of which are included herein by reference in its entirety.

### BACKGROUND

Mobile wireless communications terminals such as cellular telephones, personal digital assistants, navigation devices, mapping devices, and other mobile wireless communication devices (hereinafter “mobile terminals”), are now ubiquitous in the United States and in the entire world. For a long period of time, entities with products or services to sell have recognized a great potential in using mobile terminals as a channel to advertise their products or services. Problems exist, however, in delivery and presentation of advertising in this advertisement channel.

Unlike viewers of traditional television programming, where viewers are accustomed to, and generally accepting of, being forced to watch advertisements before, during, and after a television program, users of mobile terminals (hereinafter “users” or “mobile users”) are generally intolerant of being required to watch advertisements. Users of mobile terminals want, among other things, convenience and speed.

At least one reason for this intolerance may be due to a sense of intrusion into a user's ability to choose how to occupy personal time or what to do with personal time. There are, of course, other reasons as well.

Advertisers want mobile terminal users to see their advertisements, but heretofore have been unable to deliver advertising material to users without requiring the user to first perform an action or visit a specified website. These requirements may be perceived, by a mobile terminal user, as intruding on the user's ability to choose or may be seen as intrusive for other reasons. Advertisers have heretofore not been able to resolve the longstanding problem of how to deliver, present, or otherwise provide, non-intrusive advertising to users of mobile terminals.

Presently, a mobile advertisement may consist of a banner advertisement on a carrier's home page, which is accessed by a carrier supplied mobile browser. Under this method, the carrier supplied mobile browser takes the user directly to the carrier's Internet portal. The portal includes links to other preselected webpages. Most users never navigate away from these preselected webpages, which also contain intrusive banner advertisements. Moreover, by presenting only preselected links, the carrier controls the user's experience on the mobile terminal.

Some advertisers have attempted to entice users into viewing advertisements by entering competitions with chances to win prizes if the user texts a message to a certain address. In response to a text message sent by a user, an advertiser might return a confirmation message conspicuously loaded with advertising content. A link may be provided to a website on which the advertiser displays its advertisements or an advertising banner. The user may reach this type of webpage either through the link in the confirmation text message or as a result of enticement through some other medium. In many cases, the webpage being visited contains links to other web pages, which coincidentally also include banners or other advertisements in which the user may have no interest. Other advertisers entice users to visit a branded website using the web browser of their mobile terminal. At the branded website, users play games for free. Under all of these gimmicks, users are required to take action (e.g., text-to-win or click-to-win), which are intrusive with respect to the ways users wish to use their personal mobile terminals. In another highly intrusive method of distributing advertisements to users of mobile terminals, users are paid money or points for watching advertisements before they make a call or after they complete a call.

### SUMMARY

The present invention provides a method for a multimedia narrative tool that obviates one or more of the aforementioned problems due to the limitations of the related art.

According to an embodiment of the invention a method of non-intrusive advertising on a mobile wireless communications terminal is disclosed. The method may include storing, according to a timed schedule, a plurality of files containing data representative of a plurality of advertising images in a memory of the mobile wireless communications terminal; and selecting, upon occurrence of a predefined event, one of the plurality of files for display as wallpaper on a display screen of the mobile wireless communications terminal.

According to an embodiment of the invention a mobile wireless communications terminal is disclosed. The mobile wireless communications terminal may include a microprocessor; a display operationally coupled to the microprocessor; a memory operationally coupled to the microprocessor, the memory having stored therein data representing sequences of instructions, the sequences of instructions including a sequence of instructions which, when executed by the microprocessor, cause the microprocessor to perform steps of an application, such as the those just described above.

According to another embodiment of the invention a method of non-intrusive advertising on a mobile wireless communications terminal is described. The method may include waiting for an occurrence of a event; determining, upon the occurrence of the event, if a contraindicated condition is present in the mobile wireless communications terminal, and if the contraindicated condition is not present: selecting a file from a set of files stored in a memory of the mobile wireless communications terminal; pushing the selected file to a predetermined memory location corresponding to a folder comprising wallpaper to be displayed on a display of the mobile wireless communications terminal; saving, in an audit file, a record of an identity of the selected file pushed to the predetermined memory location; and returning to the waiting for the occurrence of the event; but if the contraindicated condition is present: returning to the waiting for the occurrence of the event.

The advantages of the invention will be realized and attained by the method and structure pointed out in the written description and claims thereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of a mobile wireless communications terminal that is able to be configured to execute the steps of a method in accordance with an embodiment of the invention.

FIG. 2 is a flow diagram of a method in accordance with an embodiment of the invention.

FIG. 3 is a system diagram illustrating advertiser, user, and service provider segments according to an embodiment of the invention.

### DETAILED DESCRIPTION OF THE EMBODIMENTS

In order to solve these and other problems, the embodiments described herein provide for the non-intrusive display of advertising images as wallpaper on a display of a mobile terminal. The advertising image, even if partially obscured by one or more other images, will be visible to a user during at least a portion of the time the mobile terminal is in use. When the user, opens or otherwise activates the mobile terminal, the advertising image will be displayed as wallpaper. The advertising image will be always present, in the sense that wallpaper is always present, but will never be intrusive and does not require a user to click on anything before the image is presented to the user. Additionally, according to the embodiments described herein, the advertising image may change based on a timed schedule, or the advertising image may change due to an occurrence of predetermined event. As used herein the term “advertising image” encompasses still images and moving images. Additionally, the term contemplates still or moving images with or without accompanying sound.

In one exemplary use of a mobile terminal in accordance with an embodiment of the invention, a user may acquire code, which, when executed, will configure a microprocessor to perform the steps of a method in accordance with an embodiment of the invention. This code may be referred to hereinafter as the “application.” In one embodiment, the method may be implemented in Java. In that embodiment, the downloaded program may be known as a MIDlet. A MIDlet is a Java program for embedded devices, more specifically the Java ME virtual machine. Some applications of MIDlets are games that run on a cellular telephone.

A user may obtain the application when becoming a member of a group providing the advertising image services. A user may not even need to take steps to acquire the application, if, for example, it is pre-loaded on the mobile terminal. Pre-loading may be performed by the mobile terminal's manufacturer, a carrier or wireless provider, or a reseller prior to or commensurate with the purchase of the mobile terminal by the user.

According to the embodiments presented herein, an advertiser will no longer need to entice a user into performing some act prior to receiving each advertisement. Nor would the advertiser be required to entice a user to visit a branded webpage from his or her mobile terminal. According to the embodiments presented herein, a user will always be presented with an advertisement when using his or her mobile terminal, because the advertisement will be the wallpaper on the user's display.

As used herein, the term wallpaper refers to an image appearing on a display, which a user will at times see, but with which the user will typically not interact. Nothing, however, in this disclosure is meant to limit the invention to the use of non-interactive wallpaper. The scope of the invention may encompass wallpaper with one or more embedded links, such that a user could interact with the wallpaper through the embedded link. Wallpaper, as used herein, may refer to the rear-most displayed image. In other words, a portion of the image displayed as wallpaper may be obscured by other, simultaneously displayed images, which appear to be displayed in front of or on top of the wallpaper. Moreover, wallpaper is not visible all the time. Wallpaper may be hidden when the mobile terminal is closed, off, running another application (e.g., e-mail or word processing), during a phone call, or during a screen saver.

Wallpaper does not encompass screen saver images. A screen saver image is understood to appear when a user has not used a mobile terminal for a preset period of time. Screen savers were first developed to prevent fixed and unchanging images from being burned into the phosphorescent coating used to display an image on a cathode ray tube (“CRT”). Today's mobile terminals do not use CRTs. Instead, liquid crystal displays are utilized. LCDs do not use phosphorescent coatings for the display of images and therefore cannot succumb to the problem of having an image burned onto the display. Wallpaper and screen savers are distinct in that wallpaper is present at all times during use of a mobile terminal, while a screen saver may be displayed only when the mobile terminal is not in use. Additionally, screen savers are understood to be displayed as the front-most image. By being the front, or top-most, image, screen savers are understood to completely hide all other images on the display.

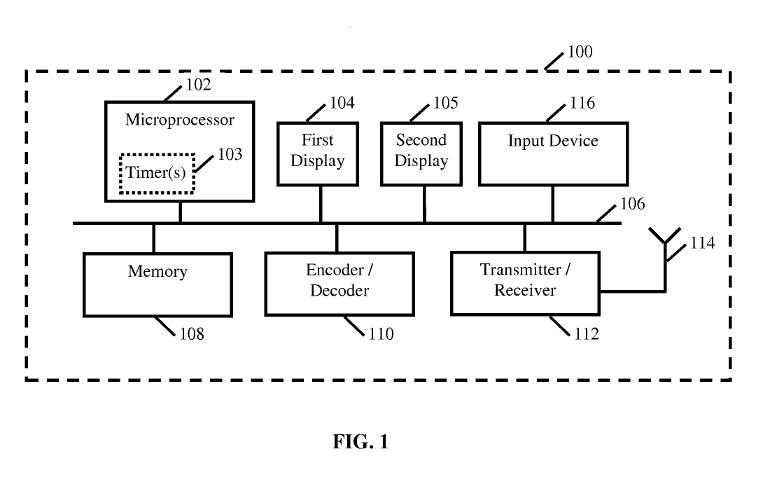

FIG. 1 is a functional block diagram of a mobile terminal that may be configured to perform a method in accordance with an embodiment of the invention. The mobile terminal 100 may comprise a microprocessor 102 and one or more displays 104, 105 that is (are) operationally coupled to the microprocessor 102 via a communications bus 106. The microprocessor 102 includes functionality that permits it to set and maintain one or more timers 103. The mobile terminal 100 may further comprise a memory 108, which is also operationally coupled to the microprocessor via the communications bus 106. The memory may include a memory structure constructed on the same substrate as the microprocessor. This portion of memory may be referred to as a memory cache or a working memory. The memory may also include memory structures that are constructed on different substrates (not on the microprocessor substrate). The memory may also include memory structures constructed on removable memory devices, such as a memory card. The memory 108 may have stored therein data representing sequences of instructions, which include sequences of instructions that, when executed by the microprocessor, cause the microprocessor to perform the steps of a method according to an embodiment of the invention described herein.

The mobile terminal may also include an encoder/decoder 110 to encode data for transmission from the mobile terminal 100 and decode data received by the mobile terminal 100. A transmitter/receiver 112 and an antenna 114 may also be included with the mobile terminal 100. In general terms, the transmitter portion of the transmitter/receiver 112 modulates encoded data for wireless transmission via the antenna 114. The receiver portion demodulates the wireless signal received by the antenna 114 for decoding by the encoder/decoder 110.

The mobile terminal 100 may also include one or more input devices 116. Examples of input devices 116 include a keypad, roller wheel, roller ball, and touch screen. The touch screen may overlay the display and be operated by human touch or the touch of a stylus. The keypad and other input devices may be implemented in hardware or may be of the virtual type. A virtual keypad, for example, may be displayed on the display and may be responsive to touches on the touch screen immediately above each virtual key. Keys, buttons, and sliding controls may all be implemented as virtual type input devices 116.

In one experimental embodiment, a software development tool named “Flash Lite” by Adobe was used to generate an application for a mobile terminal. For any mobile terminal running Flash Lite, the method comprised pushing a first file to the mobile terminal. The first file may include a plurality of subfiles, each representing an image. Also pushed to the mobile terminal was a second file, which contained data that identified when each image in the first file should be displayed. The embodiment utilizing Flash Lite provided a successful validation of the method described herein.

In another experimental embodiment, an overlay operating system for mobile terminals was utilized to develop an application. The specific overlay operating system is named Binary Runtime Environment for Wireless (“BREW”) by Qualcom. Similar to Flash Lite, BREW provides software developers with a set of tools useful for creating software. The embodiment utilizing BREW also provided a successful validation of the method described herein.

In yet another experimental embodiment, an overlay operating system for mobile terminals was utilized to develop an application. The specific overlay operating system is named ANDROID by Google. Similar to Flash Lite and BREW, ANDROID provides software developers with a set of tools useful for creating software. The embodiment utilizing BREW also provided a successful validation of the method described herein.

The successful validations of applications installed and used in mobile terminals running Flash Lite, BREW, and ANDROID demonstrate that the invention is susceptible of industrial application. The mobile terminals, which may represent articles of manufacture, are constructed with computer readable medium, where the application is locally stored on or in the computer readable medium and is executable by a processor of the mobile terminal.

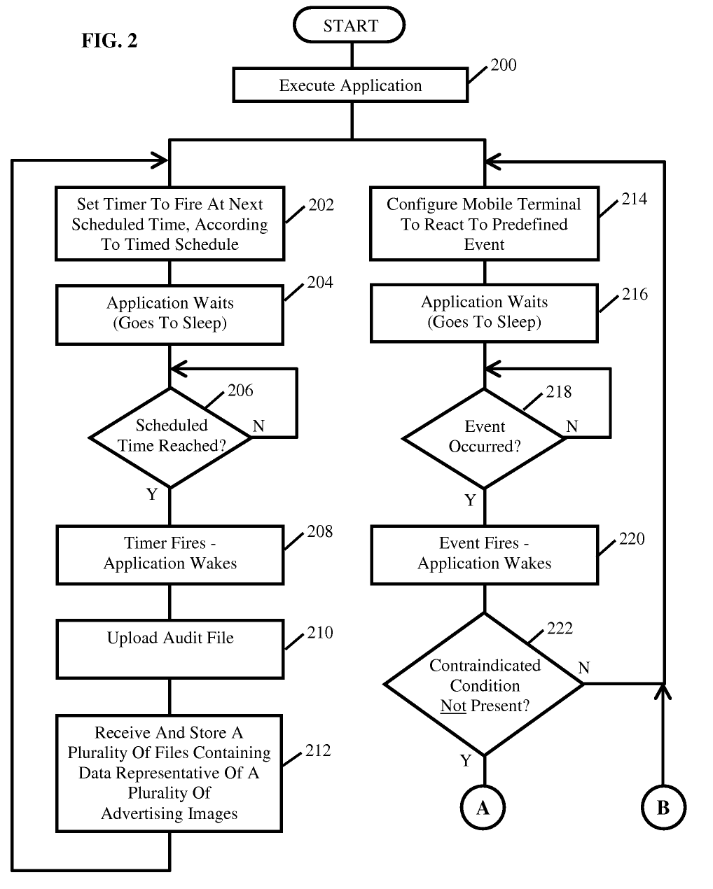

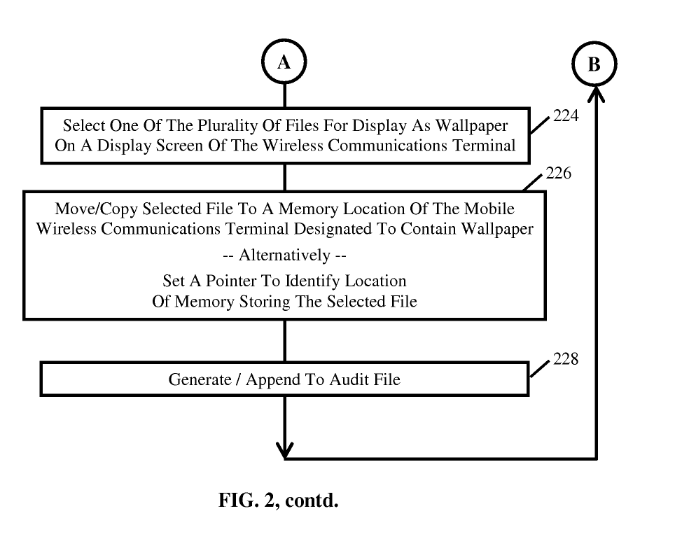

FIG. 2 is a flow diagram of a method in accordance with an embodiment of the invention. For the purposes of FIG. 2, it will be understood that an application, including the instructions to be executed to perform a method in accordance with an embodiment of the invention, was previously received, or pre-loaded, and installed on the mobile terminal (similar to mobile terminal 100 of FIG. 1). The application may be installed by pre-existing software and functions on the mobile terminal.

It is preferable, that once the application is running, it should use as few resources as possible and should be active for the shortest amount of time possible, so as to not appear to slow the normal operations of the mobile terminal. In general, to minimize resources, it is desirable to move a small image file into a folder and have the mobile terminal refresh the screen using the data of the small image file. To ensure that running the application will not cause any issues with the speed of operation of the mobile terminal, in some embodiments, the application may monitor memory (similar to memory 108, FIG. 1) and may take action intended to minimize its impact on mobile terminal performance. For example, the application may enter a sleep state if execution of the code of the application would exceed a predetermined limit on an amount of memory used for operation of the mobile terminal.

Turning to FIG. 2, at 200, the application may be executed or otherwise caused to run. The mobile terminal may have a built-in program manager that will manage the application's execution. The method proceeds in two parallel branches, beginning a first branch at 202, and a second branch at 214. If the application was previously run, it may be assumed that a timer was previously initiated.

The timer may be used to indicate when new advertising images are to be downloaded to the mobile terminal. According to embodiments of the invention described herein, new advertising images are downloaded to the mobile terminal on a timed interval. The timed interval may establish a regular schedule for downloading of a plurality of new advertising images.

By way of example, and for purposes of explanation, the timer described herein may be one of those maintained by the operating system of the mobile terminal. However, as will be understood by those of skill in the art, a timer may be configured in other ways that equivalently serve the requirements of the methods described herein.

At 202, the application may reserve and set a timer (similar to 103, FIG. 1) to fire at the next scheduled time (for downloading advertisement images). The time period to be timed until the next download may be set by a schedule.

At 204, once the application has set the timer, the application may go to sleep.

As represented by 206 and 208, the timer will not fire until the scheduled time is reached. If, at 206, the scheduled time has not been reached, 208 will not occur. If, however, at 206, the scheduled time has been reached, the method proceeds to 208, where the timer fires and the application wakes.

At 210, code may be executed by the microprocessor to cause a file to be uploaded via a wireless communication link to, for example, a central operations location. The uploaded file may be used to audit the execution of the method of the invention. The uploaded file may be referred to herein as the “audit file.” The audit file may include information detailing which advertising images were made available for display as a function of time-of-day. The uploaded file, or another separate uploaded file, may also include information on when the mobile terminal was, or was not, in an idle state, or how many times a predetermined event, such as the opening of a cover on a flip-phone style mobile terminal, or the illumination of a backlight of the display, occurred as a function of time-of-day. The scope of the invention is not limited to the preceding list. The data of these one or more uploaded files contains metrics that are of considerable value to advertisers.

At 212, a plurality of files containing data representative of a plurality of advertising images may be received and stored in a memory of the mobile terminal. The mobile terminal may download a new set of advertising images on a timed schedule. The download may be scheduled at a time when the mobile terminal is likely to not be in use, for example at 1 AM. Alternatively, in response to the uploading of the audit file(s), a system including the mobile terminal, may push a new set of advertising images to the mobile terminal.

Subsequent to 212, the method returns to 202 where a timer is again set and the above described branch of the method continues.

As stated above, the second branch operates in parallel with the first branch. Moving now to the second branch, at 214, the mobile terminal is configures to take action (i.e., react to) in response to an occurrence of a predefined event. Examples of events include a timer event, receipt of a message from a server of the advertising image service provider, and a system event. The preceding list is not meant to be limiting. Additionally, it will be understood that mobile terminal can be configured to take action upon the occurrence of any of a set of events that may be configured by the application.

By way of example, the predefined event may be the firing of a second timer, different from the timer set at 202. The second timer (similar to timer 103, FIG. 1) may be set to fire at regular timed intervals. These regular timed intervals may be used, for example, to change the advertising image should no other predefined event occur in a given time period. Other predefined events may include detection of a signal indicative of an opening, closing, sliding, rolling, or pressing of a mechanical component of the mobile terminal (or the virtual equivalent thereof on a display of a touch screen type mobile terminal). The mechanical component may be, for example, a hinged cover of a flip-phone style mobile terminal, a sliding cover of a sliding-cover style mobile terminal, a rotating cover of a rotating-cover style mobile terminal, a rotation of a track wheel or roller ball, the press of a key or other button, or the physical touch of a finger or stylus on a touch screen.

By way of further example, in the case of a virtual touch screen of a keyless mobile terminal, the predefined event may be a change of state of data stored in the memory of the wireless telecommunications mobile terminal, wherein the change of state indicates that the touch screen is enabled or disabled.

At 216, once the application has configured the mobile terminal to take action upon a predefined event (or any of a set of predefined events), the application may go to sleep.

As represented by 218 and 220, step 222 will not be reached until at least one of the predefined events occurs. If, at 218, a predefined event has occurred, the method proceeds to 220, where the event fires and the application wakes.

At 222, code may be executed to test if a contraindicated condition (or any one of a set of contraindicated conditions) with respect to the mobile terminal, is, or is not present. In exemplary FIG. 2, for ease of illustration, the test is whether the contraindicated condition is not present. A contraindicated condition may exist if a value indicative of a low battery life condition of the mobile terminal is stored in a predetermined location in the memory of the mobile terminal, or if such a state is otherwise indicated. A contraindicated condition may exist if a value indicative of an incoming or an outgoing communication to/from the mobile terminal is stored in a predetermined location in the memory of the mobile terminal, or if such a state is otherwise indicated. A contraindicated condition may exist if a value indicative of a non-idle state of the mobile terminal is stored in a predetermined location in the memory of the mobile terminal, or if such a state is otherwise indicated. The preceding examples are not meant to be limiting. Other contraindicated conditions may be defined and tested and are within the scope of the invention.

At 222, if a contraindicated condition is present exist, (i.e., the test for whether the contraindicated condition is not present is negative (or false)) the method returns to 214, where the mobile terminal may again be configured, as stated above, and then to 216, where the application may go to sleep. It is also noted that if the result of 222 is negative, the method may alternatively return to 216, for example if there is not a need to once again configure the mobile terminal before the application returns to sleep. For purposes of clarity of the figure, the path from the negative branch of 222 to 216 is not illustrated.

At 222, if a contraindicated condition is not present, (i.e., the test for whether the contraindicated condition is not present is positive (or true)) the method may proceed to 224.

At 224, one of the plurality of files previously downloaded to the mobile terminal may be selected for display, as wallpaper, on a display screen of the mobile terminal. Selection may be based on, for example, a time-of-day, a day-of-week, a day-of-month, or a week-of-month.

At 226, the selected file may be moved to, or copied to, a memory location of the mobile terminal designated to contain wallpaper. Alternatively, a pointer may be set to identify the location of memory storing the selected file. Other ways to identify the selected one of the plurality of files is to be used as wallpaper are within the scope of the invention.

At 228, the audit file, or files, may be generated (i.e., a first or new audit file may be generated subsequent to uploading of a previous audit file) or data may be appended to an existing audit file(s), if one already exists. Subsequent to 228, the method may return to 214.

It should be understood that in the normal course of operation, a mobile terminal must monitor multiple variables to determine its own status. For example, in a flip-phone style mobile terminal, a variable representative of whether the mobile terminal is open or closed must be monitored. If open, the microprocessor may execute code to display not only advertisement image (as wallpaper), but also any pertinent images in front of the advertisement image. Upon opening, the microprocessor may also execute code to turn on the backlight of the LCD display. Depending on other variables, the microprocessor may execute code to turn off the backlight after a predefined period of time. By way of example only, if the mobile terminal is in use (e.g., cover open and data being entered) then the selected advertisement image may be displayed, possibly along with other images that may overlay the advertisement image. Thus, if the mobile terminal is in use, normal operation of the mobile terminal causes, the advertisement image to be displayed (as wallpaper). If, however, the mobile terminal were not in use, the microprocessor would continuously or periodically execute code to test whether the mobile terminal was once again in use before, once again, displaying the advertisement image.

In order to provide security and integrity of the advertising images stored on a user's mobile terminal, each image might receive an electronic signature from the advertiser posting the image. The electronic signature may be checked when it is downloaded to a user's mobile terminal and may be checked again when it is selected as the new advertising image for display on the user's mobile terminal. Other methods of maintaining system security and image integrity are within the scope of the invention.

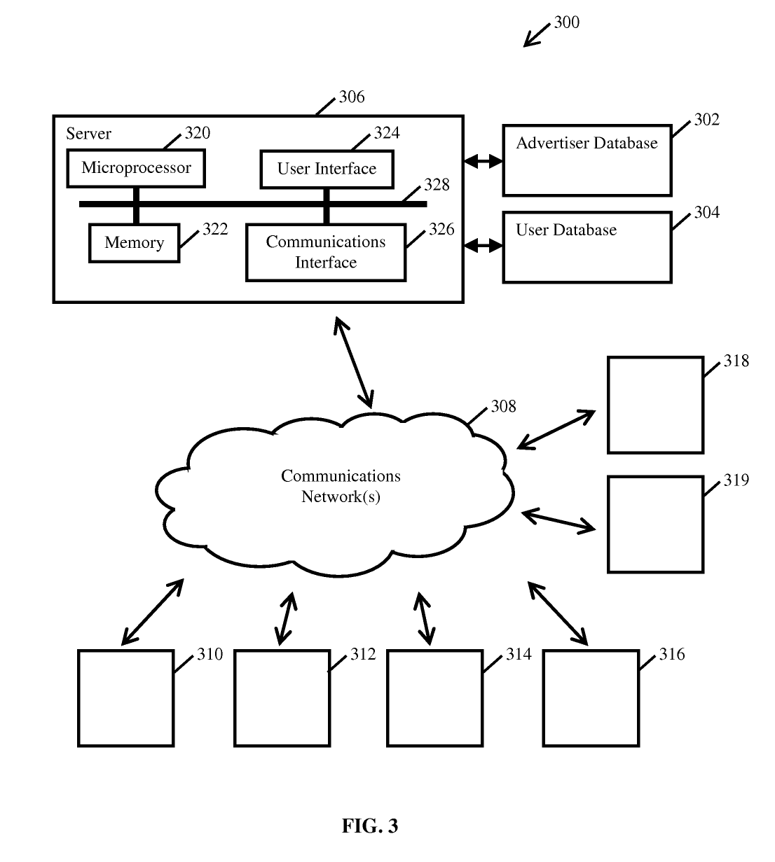

FIG. 3 is a block diagram of a system 300 according to an embodiment of the invention. The system 300 may include an advertiser database 302 comprising advertiser information, a user database 304 comprising user information, a server 306 that may be operated by an advertising image service provider. The system 300 may additionally interface with various communications networks 308, such as the Internet, public switched telephone networks, and wireless telephone networks. A plurality of mobile terminals 310, 312, 314, 316 may be wirelessly coupled to the server 306 via the communications networks 308. The mobile terminals illustrated in FIG. 3 are meant to exemplify multiple types of mobile terminals, which may perform similar of different functions and which may run on multiple operating systems. All are simultaneously useable in accordance with the embodiments of the invention described herein. While the mobile terminals 310, 312, 314, 316 may be similar to mobile terminal 100, FIG. 1, a diversity of mobile terminals is planned. For example, mobile terminals compatible with Flash Lite, BREW, ANDROID, or any other compatible scheme may all use the system simultaneously. Additionally, advertisers 318, 319 may also be coupled to the server 306 via the communications networks 308. The server 306 may include a microprocessor 320, a memory 322, a user interface 324, a communications interface 326, all coupled via a communications bus 328. The advertiser and user databases 302, 304 may be included in the memory 322. The memory 322 may be a combination of local and remote memory.

In practice, an advertiser would create an account, create a login, and provide bibliographic information at least for identification and qualification purposes. The advertiser would be provided with an image size, dependent on the types of mobile terminals to which they want to send advertisements. The advertiser would upload its advertisement image(s) to the advertiser database 302. The advertisement image(s) would be reviewed to verify that the image(s) meet the service provider's regulations. If the image(s) are approved, the service provider would send an acknowledgment to the advertiser, and charge the advertiser.

Charges may be based, for example, on how many days or minutes the advertisement will be available for viewing. Charges may be based on which days the advertisement is available for viewing. Charges may be a result of a bidding process. For example, if 10 AM to 2 PM on Saturdays in July is a prime time for selling soft drinks, one soft drink company may bid against another to have advertisements of its products made available for viewing in that time slot, or on which particular days, the advertisement should be made.

In practice, a user (i.e., a mobile user of the service) may need to initially go to a website (e.g., flypaper.com) to create an account, create a login, and provide bibliographic information, at least for identification and qualification purposes. The user may also be required to complete a survey intended to collect demographic information so that advertisements for products and services of interest to the user can be sent to the user. The user would be asked to positively acknowledge his or her interest in the service and would be required to “opt-in” to the service. By opting-in, the user would expressly acknowledge his or her desire and willingness to accept downloads of advertisement images on an ongoing basis, or for a prescribed period. Thereafter the user would not necessarily need to visit the website again.

To encourage users to look at images, users could be offered points (a.k.a. “flies”) every time they view an advertisement image. Upon accumulating a certain number of points, the user could exchange those points for products or services offered via a warehouse like operation. Users might also be encouraged to accumulate points if the accumulated points were to be donated to a charity selected by the user.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of non-intrusive advertising on a mobile wireless communications terminal, comprising:
storing, according to a timed schedule, a plurality of files containing data representative of a plurality of advertising images in a memory of the mobile wireless communications terminal;
selecting, upon occurrence of a predefined event, one of the plurality of files for display as wallpaper on a display screen of the mobile wireless communications terminal.

2. The method of claim 1, wherein the selecting is based on a time-of-day, a day-of-week, a day-of-month, or a week-of-month.

3. The method of claim 1, wherein the plurality of advertising images comprise moving images, still images, or a combination of moving and still images.

4. The method of claim 1, wherein the plurality of files containing data representative of a plurality of advertising images further comprises data representative of audio associated with the plurality of advertising images.

5. The method of claim 1, wherein the plurality of files containing data representative of a plurality of advertising images further comprises data representative of the predefined event required to select at least one of the plurality of files for display as wallpaper on a display screen of the mobile wireless communications terminal.

6. The method of claim 1, further comprising, pushing, subsequent to selecting, the selected one of the plurality of files to a memory location of the mobile wireless communications terminal designated to contain wallpaper.

7. The method of claim 1, wherein the predefined event is a trigger signal output from an internal wake-up timer.

8. The method of claim 7, wherein the internal wake-up timer is preset to output the trigger signal at regular intervals.

9. The method of claim 1, wherein the predefined event is an opening or a closing of a mechanical component of the mobile wireless communications terminal.

10. The method of claim 9, wherein the mechanical component is a hinged cover of the mobile wireless communications terminal, a sliding cover of the mobile wireless communications terminal, or a rotating cover of the mobile wireless communications terminal.

11. The method of claim 1, wherein the predefined event is a change of state of data stored in a memory of the wireless telecommunications terminal, wherein the change of state indicates that a touch screen of the mobile wireless communications terminal is enabled or disabled for input.

12. The method of claim 1, wherein the predefined event is a detection of an entry to, or an exit from, an idle state of the mobile wireless communications terminal.

13. The method of claim 1, further comprising displaying, as wallpaper, the advertising image of the selected one of the plurality of files on the display of the mobile wireless communications terminal.

14. The method of claim 1, further comprising:
determining, prior to selecting, if a contraindicated condition exists in the mobile wireless communications terminal; and
if the contraindicated condition does not exist, performing the selecting; and
if the contraindicated condition does exist, waiting for a subsequent occurrence of the predefined event before again determining if a contraindicated condition is present in the mobile wireless communications terminal.

15. The method of claim 14, wherein the contraindicated condition exists if a value indicative of a low battery life condition of the mobile wireless communications terminal is stored in a predetermined location in the memory of the mobile wireless communications terminal.

16. The method of claim 14, wherein the contraindicated condition exists if a value indicative of an incoming or an outgoing communication to/from the mobile wireless communications terminal is stored in a predetermined location in the memory of the mobile wireless communications terminal.

17. The method of claim 14, wherein the contraindicated condition exists if a value indicative of a non-idle state of the mobile wireless communications terminal is stored in a predetermined location in the memory of the mobile wireless communications terminal.

18. A mobile wireless communications terminal, comprising:
a microprocessor;
a display operationally coupled to the microprocessor;
a memory operationally coupled to the microprocessor, the memory having stored therein data representing sequences of instructions, the sequences of instructions including a sequence of instructions which, when executed by the microprocessor, cause the microprocessor to perform the steps of:
storing, on a timed schedule, a plurality of files containing data representative of a plurality of advertising images in a memory of the mobile wireless communications terminal;
selecting, upon occurrence of a predefined event, one of the plurality of files for display as wallpaper on a display screen of the mobile wireless communications terminal.

19. The mobile wireless communications terminal of claim 18, wherein the timed schedule is based on a time-of-day, a day-of-week, a day-of-month, or a week-of-month.

20. The mobile wireless communications terminal of claim 18, wherein the plurality of advertising images comprise moving images, still images, or a combination of moving and still images.

21. The mobile wireless communications terminal of claim 18, wherein the plurality of files containing data representative of a plurality of advertising images further comprises data representative of audio associated with the plurality of advertising images.

22. The mobile wireless communications terminal of claim 18, wherein the plurality of files containing data representative of a plurality of advertising images further comprises data representative of the predefined event required to select at least one of the plurality of files for display as wallpaper on a display screen of the mobile wireless communications terminal.

23. The mobile wireless communications terminal of claim 18, further comprising, pushing, subsequent to selecting, the selected one of the plurality of files to a memory location of the mobile wireless communications terminal designated to contain wallpaper.

24. The mobile wireless communications terminal of claim 18, wherein the predefined event is a trigger signal output from an internal wake-up timer.

25. The mobile wireless communications terminal of claim 24, wherein the internal wake-up timer is preset to output the trigger signal at regular intervals.

26. The mobile wireless communications terminal of claim 18, wherein the predefined event is an opening or a closing of a mechanical component of the mobile wireless communications terminal.

27. The mobile wireless communications terminal of claim 26, wherein the mechanical component is a hinged cover of the mobile wireless communications terminal, a sliding cover of the mobile wireless communications terminal, or a rotating cover of the mobile wireless communications terminal.

28. The mobile wireless communications terminal of claim 18, wherein the predefined event is a change of state of data stored in a memory of the wireless telecommunications terminal, wherein the change of state indicates that a touch screen of the mobile wireless communications terminal is enabled or disabled for input.

29. The mobile wireless communications terminal of claim 18, wherein the predefined event is a detection of an entry to, or an exit from, an idle state of the mobile wireless communications terminal.

30. The mobile wireless communications terminal of claim 18, further comprising displaying, as wallpaper, the advertising image of the selected one of the plurality of files on the display of the mobile wireless communications terminal.

31. The mobile wireless communications terminal of claim 18, further comprising:
determining, prior to selecting, if a contraindicated condition is present in the mobile wireless communications terminal; and
if the contraindicated condition is not present, performing the selecting; and
if the contraindicated condition is present, waiting for a subsequent occurrence of the predefined event before again determining if a contraindicated condition is present in the mobile wireless communications terminal.

32. The mobile wireless communications terminal of claim 31, wherein the contraindicated condition is present if a value indicative of a low battery life condition of the mobile wireless communications terminal is stored in a predetermined location in the memory of the mobile wireless communications terminal.

33. The mobile wireless communications terminal of claim 31, wherein the contraindicated condition is present if a value indicative of an incoming or an outgoing communication to/from the mobile wireless communications terminal is stored in a predetermined location in the memory of the mobile wireless communications terminal.

34. The mobile wireless communications terminal of claim 31, wherein the contraindicated condition is present if a value indicative of a non-idle state of the mobile wireless communications terminal is stored in a predetermined location in the memory of the mobile wireless communications terminal.

35. A method of non-intrusive advertising on a mobile wireless communications terminal, comprising:
waiting for an occurrence of a event;
determining, upon the occurrence of the event, if a contraindicated condition is present in the mobile wireless communications terminal, and
if the contraindicated condition is not present:
selecting a file from a set of files stored in a memory of the mobile wireless communications terminal;
pushing the selected file to a predetermined memory location corresponding to a folder comprising wallpaper to be displayed on a display of the mobile wireless communications terminal; and
saving, in an audit file, a record of an identity of the selected file pushed to the predetermined memory location; and
returning to the waiting for the occurrence of the event; and
if the contraindicated condition is present:
returning to the waiting for the occurrence of the event.

36. The method of claim 35, further comprising:
waking, from sleep, an application comprising code to perform the method prior to determining if the contraindicated condition is present; and
returning, to sleep, the application comprising code to perform the method:
if the contraindicated condition is present, or
after saving the record.

37. The method of claim 36, further comprising displaying an image representative of data stored in the file as the wallpaper on the display of the mobile wireless communications terminal when the mobile wireless communications terminal is in use.

38. The method of claim 35, wherein the contraindicated condition is present if a value indicative of a low battery life condition of the mobile wireless communications terminal is stored in a predetermined location in the memory of the mobile wireless communications terminal.

39. The method of claim 35, wherein the contraindicated condition is present if a value indicative of an incoming or an outgoing communication to/from the mobile wireless communications terminal is stored in a predetermined location in the memory of the mobile wireless communications terminal.

40. The method of claim 35, wherein the contraindicated condition is present if a value indicative of a non-idle state of the mobile wireless communications terminal is stored in a predetermined location in the memory of the mobile wireless communications terminal.
